(19) United States
(12) Patent Application Publication
(10) Pub. No.: US 2024/0419874 A1
(43) Pub. Date: Dec. 19, 2024

(54) GRAPHICS PROCESSING UNIT (GPU)-BASED NUMERICAL SIMULATION SYSTEM AND METHOD FOR HELICOPTER FLOW FIELD (FF)

(71) Applicant: NANJING UNIVERSITY OF AERONAUTICS AND ASTRONAUTICS, Nanjing (CN)

(72) Inventors: Zhiyuan HU, Nanjing (CN); Yongjie SHI, Nanjing (CN); Guohua XU, Nanjing (CN); Yang LIU, Nanjing (CN); Jiahao ZHU, Nanjing (CN)

(73) Assignee: NANJING UNIVERSITY OF AERONAUTICS AND ASTRONAUTICS, Nanjing (CN)

(21) Appl. No.: 18/702,840

(22) PCT Filed: Apr. 28, 2023
(86) PCT No.: PCT/CN2023/091413

§ 371 Date: Apr. 19, 2024

(30) Foreign Application Priority Data
May 12, 2022 (CN) 202210516285.9

(51) Int. Cl. G06F 30/28; G06F 111/10; G06F 113/08; G06T 1/20

(52) U.S. Cl. CPC G06F 30/28; G06T 1/20; G06F 2111/10; G06F 2113/08

(57) ABSTRACT

A graphics processing unit (GPU)-based numerical simulation system and method for a helicopter flow field (FF). The GPU-based system includes a central processing unit (CPU) and a GPU. The CPU is configured to initialize a moving overset grid according to a preset configuration file and the mesh files of a to-be-simulated helicopter; determine face batch information according to mesh blocks in the moving overset grid; determine an overset interpolation relationship between the mesh blocks and an interpolation mapping index according to the mesh files at a current simulation moment; and perform FF information exchanging between the mesh blocks according to the overset interpolation relationship, the interpolation mapping index, and FF information of the mesh blocks, to obtain to-be-simulated helicopter FF information. The GPU computes the FF information of the mesh blocks in the motion nested mesh according to surface batch information by using a computational fluid dynamics (CFD) method.

### REFERENCE TO RELATED APPLICATIONS

This application is a National Stage of International Patent Application No. PCT/CN2023/091413, filed on Apr. 28, 2023, which claims priority to Chinese Patent Application No. 202210516285.9, filed with the China National Intellectual Property Administration (CNIPA) on May 12, 2022, and entitled “GRAPHICS PROCESSING UNIT (GPU)-BASED NUMERICAL SIMULATION SYSTEM AND METHOD FOR HELICOPTER FLOW FIELD (FF),” which are incorporated herein by reference in their entirety.

### TECHNICAL FIELD

The present disclosure relates to the field of computer numerical simulation, and in particular, to a GPU-based numerical simulation system and method for a helicopter FF.

### BACKGROUND ART

With design refinement and a requirement for obtaining a higher-precision analysis result, the number of meshes used in Computational Fluid Dynamics (CFD) numerical simulation increased several times in the last decade. However, with the failure of Moore's law, the single-core performance of a microprocessor is not significantly improved. Searching for effective parallel and acceleration technologies has become a hot spot in current CFD solver development. A GPU is an excellent accelerator due to the high-performance floating-point (FP) arithmetic capability of the GPU. In addition, an existing study shows that using a single GPU for acceleration can achieve more than 10 times in CFD solving, which has a considerable acceleration potential.

However, these GPU acceleration computing methods take into account only steady FF simulation of a fixed wing with a simple structured mesh, but are not suitable for a motion unsteady FF environment in helicopter flow field simulation and a case scenario of unstructured meshes used extensively in the helicopter simulation. For a requirement of unsteady motion, a moving overset grid assembly technology is usually used in helicopter FF simulation. However, an algorithm of the technology includes a large quantity of logical processes for branch judgment, and is more suitable for Central Processing Unit (CPU) computing, but is difficult to program on a GPU. Running efficiency is slower on the GPU than on the CPU.

Based on the foregoing problems, a new simulation method is urgently needed to improve the numerical simulation efficiency of a helicopter FF.

### SUMMARY OF THE INVENTION

The present disclosure aims to provide a GPU-based numerical simulation system and method for a helicopter FF, which can improve the simulation efficiency of a helicopter FF.

To achieve the above objective, the present disclosure provides the following technical solutions.

A GPU-based numerical simulation system for a helicopter FF is provided and includes a CPU and a GPU, where the CPU is connected to the GPU:

the CPU further includes:

an initialization module, configured to initialize a moving overset grid according to the preset configuration file and the mesh files of a to-be-simulated helicopter, where the moving overset grids includes multiple mesh blocks:

a face batch determining module, connected to the GPU, and configured to determine face batch information according to the mesh blocks in the moving overset grid, and send the face batch information to the GPU, where the face batch information includes multiple batches, and a set of faces and cell corresponding to each batch:

an interpolation module, configured to determine the overset interpolation relationship between the mesh blocks and the interpolation mapping index according to the mesh files of the to-be-simulated helicopter at a current simulation moment; and

an FF determining module, separately connected to the interpolation module and the GPU, and configured to perform FF information exchanging between the mesh blocks according to the overset interpolation relationship, the interpolation mapping index, and FF information of the mesh blocks, to obtain to-be-simulated helicopter FF information, where the FF information includes density, velocity, and pressure; and

the GPU is separately connected to the face batch determining module and the FF determining module, and the GPU is configured to compute the FF information of the mesh blocks in the moving overset grid according to the face batch information by using a CFD method, and send the FF information to the CPU.

Optionally, the GPU is further configured to convert the FF information of the mesh blocks into an array of structure (AoS) form, and send the FF information to the FF determining module.

Optionally, each of the mesh blocks includes multiple faces and multiple cells; and the face batch determining module includes:
an initialization submodule, configured to initialize, for any batch, a selected face set in the batch to empty:
a marking submodule, configured to: mark any face whose batch is undetermined in the mesh blocks as a selected face set in the batch, mark left and right cells of the face as occupied bodies, and mark another face of the occupied bodies as a collision face:
a traversal submodule, separately connected to the marking submodule and the initialization submodule, and configured to: sequentially traverse remaining faces whose batches are undetermined and that are adjacent to the selected face set; and if left or right cells of one of the faces are not occupied, mark this face as a selected face set in the batch, and mark the corresponding left or right cells as occupied bodies; and
a batch determining submodule, separately connected to the traversal submodule and the GPU, and configured to obtain the face batch information after batches of all the faces in the mesh blocks are determined.

Optionally, the GPU includes:
flux values determining module, connected to the face batch determining module, and configured to compute, for any batch, flux values of each face in parallel in the batch according to a preset boundary condition by using the CFD method:
an updating module, connected to the flux values determining module, and configured to update the flux values to left and right cells of the face; and
a mesh block FF determining module, separately connected to the updating module and the FF determining module, and configured to determine the FF information of the mesh blocks according to the flux values of the cells.

To achieve the above objective, the present disclosure further provides the following technical solutions.

A GPU-based numerical simulation method for a helicopter FF is provided and applied to the foregoing GPU-based numerical simulation system for a helicopter FF, and includes:
initializing the moving overset grids according to the preset configuration file and the mesh files of a to-be-simulated helicopter by using a CPU, where the moving overset grid includes multiple mesh blocks:
determining face batch information according to the mesh blocks in the moving overset grids by using the CPU, where the face batch information includes multiple batches and a set of faces and cells corresponding to each batch:
computing FF information of the mesh blocks in the moving overset grid according to the face batch information by using a GPU and a CFD method, where the FF information includes density, velocity, and pressure; and
determining an overset interpolation relationship between the mesh blocks and an interpolation mapping index according to the mesh files of the to-be-simulated helicopter at a current simulation moment by using the CPU, and performing FF information exchanging between the mesh blocks according to the overset interpolation relationship, the interpolation mapping index, and the FF information of the mesh blocks, to obtain to-be-simulated helicopter FF information.

Optionally, the GPU-based numerical simulation method for a helicopter FF further includes:
converting the FF information of the mesh blocks into an AoS form using the GPU.

Optionally, each of the mesh blocks includes multiple faces and multiple cells; and the determining face batch information according to the mesh blocks in the moving overset grid by using the CPU specifically includes:
initializing, for any batch, a selected face set in the batch to empty:
marking any face whose batch is undetermined in the mesh blocks as a selected face set in the batch, marking left and right cells of the face as occupied bodies, and marking another face of the occupied bodies as a collision face:
sequentially traversing remaining faces whose batches are undetermined and that are adjacent to the selected face set: if the left and right cells of one of the faces are not occupied, marking the face as a selected face in the batch, and marking the corresponding left and right cells as occupied bodies; and determining a next batch after traversing is completed; and
obtaining the face batch information after batches of all the faces in the mesh blocks are determined.

Optionally, the computing FF information of the mesh blocks in the moving overset grid according to the face batch information by using a GPU and a CFD method specifically includes:
computing, for any batch, flux values of each face in parallel in the batch according to a preset boundary condition by using the CFD method:
updating the flux value to the left and right cells of the face; and
determining the FF information of the mesh blocks according to the flux values of the cells.

According to the specific embodiments of the present disclosure, the present disclosure provides the following technical effects: The moving overset grid is initialized in the CPU: the face batch information is determined: the FF information of the mesh blocks is determined in the GPU according to the face batch information by using the CFD method; and FF information exchanging between the mesh blocks is performed in the CPU according to the overset interpolation relationship, the interpolation mapping index, and the FF information of the mesh blocks, to obtain the to-be-simulated helicopter FF information. The CPU and the GPU are combined for numerical simulation of the helicopter FF, improving the simulation velocity of a helicopter FF.

### BRIEF DESCRIPTION OF THE DRAWINGS

To describe the technical solutions in embodiments of the present disclosure or in the conventional technology more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic structural diagram of modules of a GPU-based numerical simulation system for a helicopter FF according to the present disclosure;

FIG. 2 is a flowchart of a GPU-based numerical simulation method for a helicopter FF according to the present disclosure:

FIG. 3 is an overall flowchart of a GPU-based numerical simulation method for a helicopter FF according to the present disclosure:

FIG. 4 is a schematic diagram of a process of selecting a face:

FIG. 5 is a schematic diagram of a batch result of mesh blocks:

FIG. 6 is a schematic diagram of the cross-sectional pressure distribution of the Caradonna-Tung helicopter at 0.89 times radius of the rotor blade, which is computed by using a GPU:

FIG. 7 is a comparison diagram of a residual value convergence curve of 0-10 iteration steps in CPU and GPU computing; and

FIG. 8 is a comparison diagram of a residual value convergence curve of 2870-2880 iteration steps in CPU and GPU computing.

### DESCRIPTION OF REFERENCE NUMERALS

CPU-1, initialization module-11, face batch determining module-12, interpolation module-13, FF determining module-14, GPU-2, flux values determining module-21, updating module-22, and mesh block FF determining module-23.

### DETAILED DESCRIPTION

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

The present disclosure aims to provide a GPU-based system and numerical simulation method for a helicopter FF. The CPU is used to simulate a motion nesting process, and the GPU performs FF computing. Combining the CPU with the GPU can improve the simulation performance of a helicopter FF.

To make the above objective, features, and advantages of the present disclosure more obvious and easy to understand, the following describes the present disclosure in more detail with reference to accompanying drawings and specific implementations.

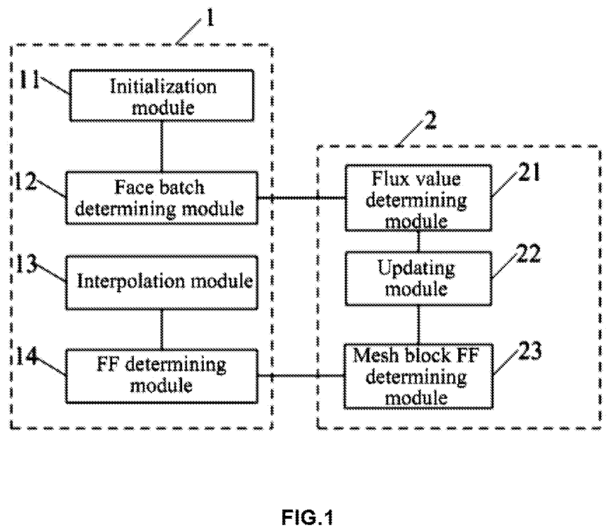

As shown in FIG. 1, a GPU-based numerical simulation system for a helicopter FF in the present disclosure includes a CPU 1 and a GPU 2, and the CPU 1 is connected to the GPU 2.

The CPU 1 includes an initialization module 11, a face batch determining module 12, an interpolation module 13, and an FF determining module 14.

The initialization module 11 is configured to initialize a moving overset grid according to a preset configuration file and the mesh files of a to-be-simulated helicopter, where the moving overset grid includes multiple mesh blocks.

The face batch determining module 12 is connected to the GPU 2, and the face batch determining module 12 is configured to determine face batch information according to the mesh blocks in the moving overset grid, and send the face batch information to the GPU 2, where the face batch information includes multiple batches and a set of faces and cells corresponding to each batch. Specifically, a CPU side calls a driver function interface to copy the face batch information from the CPU's random-access memory (RAM) to the GPU's graphics random-access memory (GRAM).

The interpolation module 13 is configured to determine an overset interpolation relationship between the mesh blocks and the interpolation mapping index according to the mesh files of the to-be-simulated helicopter at a current simulation moment.

The FF determining module 14 is separately connected to the interpolation module 13 and the GPU 2, and the FF determining module 14 is configured to perform FF information exchanging between the mesh blocks according to the overset interpolation relationship, the interpolation mapping index, and FF information of the mesh blocks, to obtain to-be-simulated helicopter FF information, where the FF information includes density, velocity, and pressure.

The GPU 2 is separately connected to the face batch determining module 12 and the FF determining module 14, and the GPU 2 is configured to compute the FF information of the mesh blocks in the moving overset grid according to the face batch information by using a CFD method, and send the FF information to the CPU 1.

To make forms of data processed by the CPU and the GPU consistent, the GPU 2 is further configured to convert the FF information of the mesh blocks into an AoS form, and send the FF information to the FF determining module 14.

Further, the mesh block includes multiple faces and cells; and the face batch determining module 12 includes an initialization submodule, a marking submodule, a traversal submodule, and a batch determining submodule.

The initialization submodule is configured to initialize, for any batch, a selected face set in the batch to empty.

The marking submodule is configured to: mark any face whose batch is undetermined in the mesh blocks as a selected face set in the batch, mark left and right cells of the face as occupied bodies, and mark another face of the occupied bodies as a collision face.

The traversal submodule is separately connected to the marking submodule and the initialization submodule, and the traversal submodule is configured to: sequentially traverse remaining faces whose batches are undetermined and that are adjacent to the selected face set; and if left and right cells of a face are not occupied, mark the face as a selected face set in the batch, and mark corresponding left and right cells as occupied bodies.

The batch determining submodule is separately connected to the traversal submodule and the GPU 2, and is configured to obtain the face batch information after batches of all the faces in the mesh blocks are determined.

Further, the GPU 2 includes flux values determining module 21, an updating module 22, and a mesh block FF determining module 23.

The flux values determining module 21 are connected to the face batch determining module 12, and the flux values determining module 21 are configured to compute, for any batch, flux values of each face in parallel in the batch according to a preset boundary condition by using the CFD method. Specifically, flux values of multiple faces may be simultaneously determined by using stream processors in the GPU to work in parallel.

The updating module 22 is connected to the flux values determining module 21, and the updating module 22 is configured to update the flux values to the left and right cells of the face.

The mesh block FF determining module 23 is separately connected to the updating module 22 and the FF determining module 14, and the mesh block FF determining module 23 is configured to determine the FF information of the mesh blocks according to the flux values of the cells.

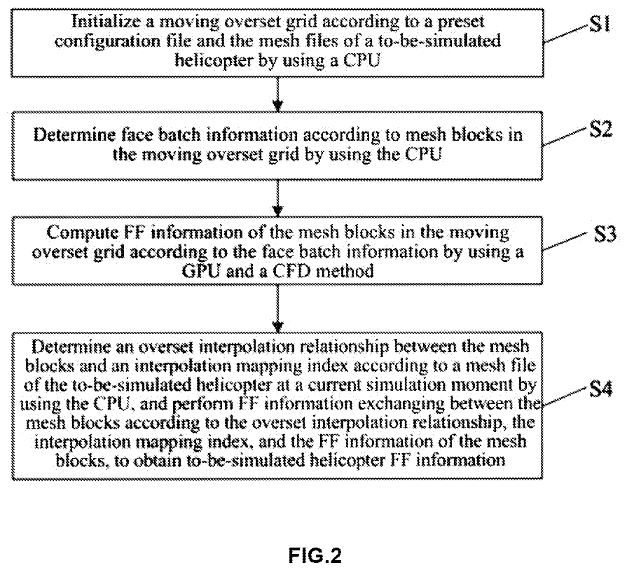

As shown in FIG. 2, a GPU-based numerical simulation method for a helicopter FF in the present disclosure includes the following steps.

S1: Initialize a moving overset grid according to a preset configuration file and the mesh files of a to-be-simulated helicopter by using a CPU, where the moving overset grid includes multiple mesh blocks. The mesh blocks include an original blade mesh block, a fuselage mesh block, and the like.

Specifically, a configuration file set by a user and the to-be-simulated helicopter mesh files are read by using the CPU. The to-be-simulated helicopter mesh file includes each blade mesh block, a fuselage mesh block, and a tail blade mesh block of a helicopter. There is an overset relationship between the mesh blocks, and an overset interpolation relationship between pairwise mesh blocks is not fixed. That is, one blade mesh block may be interpolated with an adjacent blade mesh block and the fuselage mesh block, there is an interpolation relationship between the fuselage mesh block and each of the blade mesh block and the tail blade mesh block, and so on.

In this embodiment, the configuration file includes a number, a name, and a solution configuration parameter of the mesh block. Specifically, the solution configuration parameter may be in a time discretization manner, a spatial discretization manner, or the like. A global solution configuration parameter includes several time steps of solution simulation, a convergence residual condition, a maximum quantity of iteration steps, a motion transformation equation, a motion equation associated with a mesh block, and nesting associated with a mesh block. Motion nesting is initialized according to the motion transformation equation, the motion equation associated with a mesh block, and an overset configuration associated with a mesh block (for example, an overset search and an interpolation boundary form). That is, the moving overset grid is initialized according to mesh motion information and overset configuration information.

S2: Determine face batch information according to the mesh blocks in the moving overset grid by using the CPU, where the face batch information includes multiple batches and a set of faces and cells corresponding to each batch. The face in the batch is represented by a face index.

S3: Compute FF information of the mesh blocks in the moving overset grid according to the face batch information by using a GPU and a CFD method, where the FF information includes density, velocity, and pressure.

S4: Determine an overset interpolation relationship between the mesh blocks and an interpolation mapping index according to the mesh files of the to-be-simulated helicopter at a current simulation moment by using the CPU, and perform FF information exchanging between the mesh blocks according to the overset interpolation relationship, the interpolation mapping index, and the FF information of the mesh blocks, to obtain to-be-simulated helicopter FF information. The interpolation mapping index is an index of FF interpolation between two mesh blocks. Specifically, the interpolation mapping index refers to the FF data of a cell in a mesh block can be obtained by using interpolation in which cell of another mesh block. In this embodiment, linear interpolation or least squares interpolation may be used to perform FF information exchanging between the mesh blocks.

Specifically, the CPU computes the overset interpolation relationship according to the coordinates of each mesh block in the to-be-simulated helicopter mesh file at the current simulation moment. Specifically, an interpolation mapping relationship between some meshes in two mesh blocks is obtained according to mesh geometry relationship information at a motion moment, for example, a cell M in a mesh block A is obtained by interpolating a cell N in a mesh block B.

To make forms of data processed by the CPU and the GPU consistent, the GPU-based numerical simulation method for a helicopter FF further includes: S5: Convert the FF information of the mesh blocks into an AoS form by using the GPU. The FF information obtained by the GPU is in a Structure of Array (SoA), is converted into an AoS, and is sent to the CPU. The CPU performs FF information exchange according to the converted FF information.

Further, the mesh block includes multiple faces and multiple cells. Step S2 specifically the following steps.

S21: Initialize, for any batch, a selected face set in the batch to empty. In this case, flags indicating that cells are occupied are all “No.”

S22: Mark any face whose batch is undetermined in the mesh blocks as a selected face set in the batch, mark the left and right cells of the face as occupied bodies, and mark another face of the occupied bodies as a collision face. That is, flags indicating that the left and right cells of the face are occupied are set to “yes.”

S23: Sequentially traverses remaining faces whose batches are undetermined and that are adjacent to the selected face set: if left and right cells of the face are not occupied, mark the face as a selected face set in the batch, and mark corresponding left and right cells as occupied bodies; and determine a next batch after traversing is completed. In this embodiment, in the process of determining each batch, all selected face sets are used as one batch. If there is still a face whose batch is undetermined, a new batch is created, and step S21 is performed.

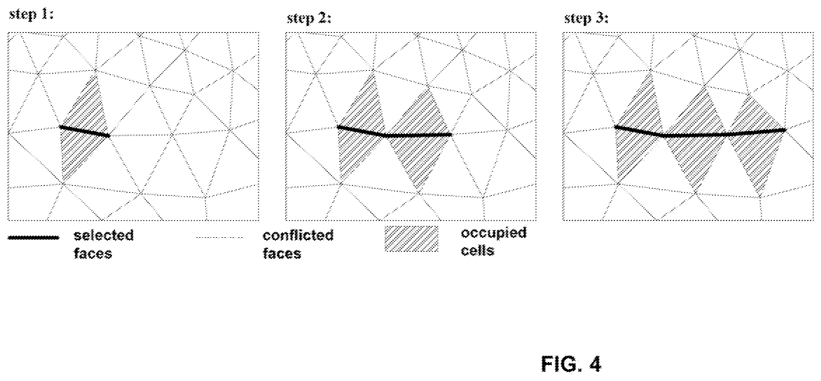

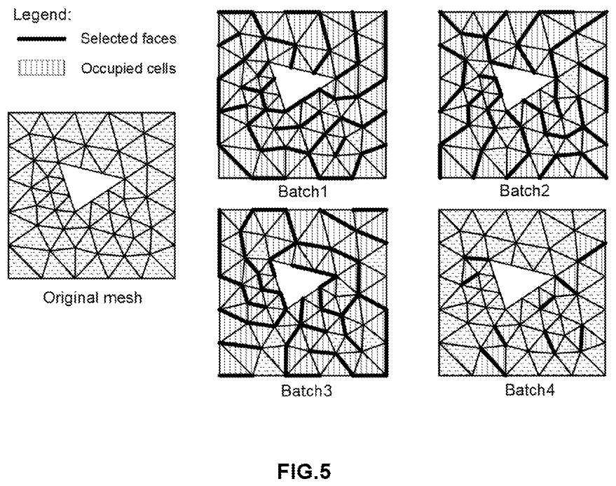

When a batch is constructed, the process of selecting a face is shown in FIG. 4. For an unstructured mesh, the result of constructing a face batch is shown in FIG. 5.

S24: Obtain the face batch information after batches of all the faces in the mesh blocks are determined.

Specifically, the construction of the face batch information is computed by the CPU according to spatial association information of the faces and the cells of the mesh blocks in the overset mesh. An obtained index of the face in the batch is used by the GPU to compute the face flux values of the face in the batch in parallel during the computing of a solution iteration step.

In this embodiment, a basic feature of the face batch information includes: All faces of the mesh blocks are divided into several batches, and the left and right cells of the faces in the batches are not repeated. FF information computing may be independently performed in parallel on the faces in the batches. The next batch needs to be started after a previous batch is completed. Further, step S3 specifically includes the following steps.

S31: Compute, for any batch, flux values of each face in parallel in the batch according to a preset boundary condition by using the CFD method. Specifically, the flux values are divided into different spatial discrete schemes in a CFD solution manner. For example, the simplest central difference is to take a difference between FF data of the left and right two cells of a face as a flux. Computing modes according to other rules include an upwind scheme, a total variation diminishing (TVD) scheme, and the like. A specific computing mode may be determined according to an actual requirement.

S32: Update the flux values to the left and right cells of the face.

S33: Determine the FF information of the mesh blocks according to the flux values of the cells.

In this embodiment, the boundary condition is set by the user according to a simulation requirement. For example, usually, in the blade mesh block, a boundary condition of a face that composes a blade shape is set to an object plane (whose flux is 0, and which cannot be penetrated by fluid). A mesh face set of the outermost layer is set to a pressure far field (whose velocity gradient is 0). The rest are interior faces, in which the fluid can flow freely. In addition, there are boundary conditions such as a symmetric boundary and a periodic boundary, which are set by the user according to simulation requirements.

Specifically, an iteration of a CFD FF is to append the flux values of the face to the cell adjacent to the face. For example, the face flux values are subtracted from the outflow FF data of the cell, and the face flux values are added to the inflow FF data of the cell. However, this is not necessarily a simple direct addition/subtraction, but in a specific manner, for example, a coefficient is multiplied by. Different manners form different CFD time-advancement schemes. A specific computing mode may be set according to a CFD computing requirement.

The foregoing step S3 occupies most of the computing overheads of the iterative solution step. When this algorithm is conventionally executed serially on all faces in the CPU without batching, step S31 needs to be completed first and then step S33 is performed, to ensure correctness of a solution result. However, this makes an implementation of parallel computing in the GPU difficult and inefficient. Because a corresponding data synchronization mechanism is needed to ensure that a sequence of updating the face flux values to the left and right cells of the face during parallel execution of the GPU is consistent with that of serial execution in the CPU. This increases program complexity, occupies extra cache space, and reduces running efficiency. Therefore, in the present disclosure, parallel computing is performed by using a batch computing policy, further improving the efficiency of FF simulation.

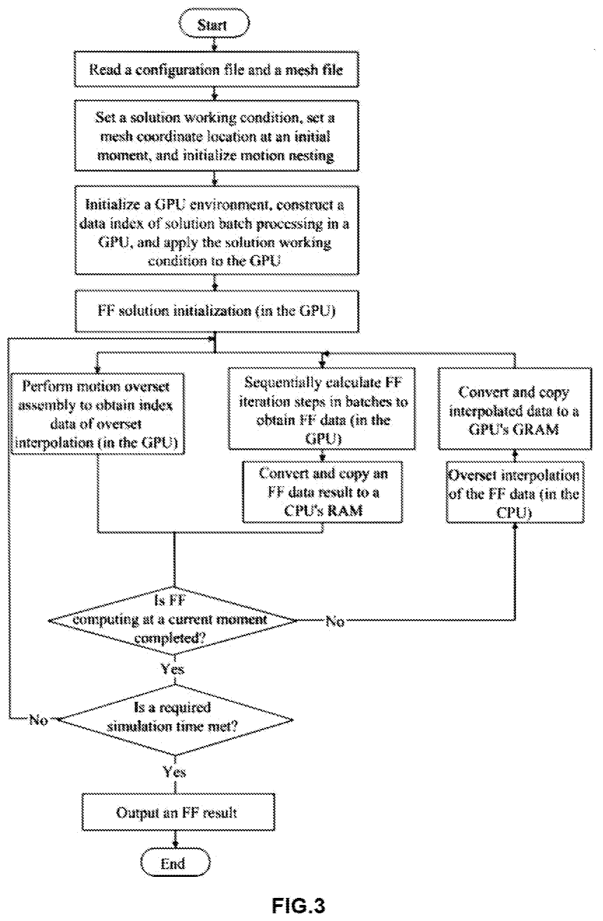

In addition, as shown in FIG. 3, the GPU-based numerical simulation method for a helicopter FF in the present disclosure further includes: setting a solution working condition according to the configuration file by using the CPU, and setting coordinate locations of the mesh blocks at an initial moment according to the configuration file and original coordinate information in the to-be-simulated helicopter mesh file. A GPU computing environment is configured by using the CPU according to the GPU device setting information in the configuration file. Specifically, the CPU calls a driver function interface of the GPU, so that the GPU initializes a context environment. FF solution initialization is performed by using the GPU. Specifically, a CPU side calls the driver function interface, so that the GPU executes a core function of the GPU to perform FF solution initialization.

In this embodiment, the GPU computes FF information of the mesh blocks in the face batch information at a given motion location according to the solution working condition by using the CFD method.

The CPU determines, according to an iteration step or a convergence condition in the configuration file, whether FF computing at a current moment is completed. If yes, a simulation moment is set to the next moment, and the CPU determines, according to a required simulation time in the configuration file, whether FF computing is completed. If yes, an FF result is output and the process ends: or if no, the CPU sets a mesh location at the current simulation moment, updates location information to the GPU, and computes the FF information again.

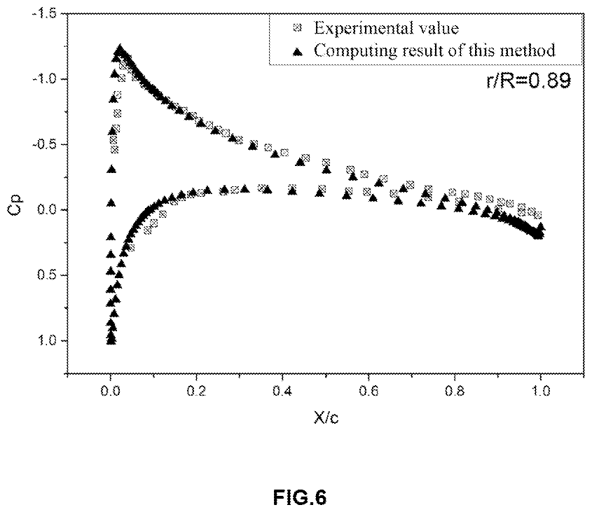

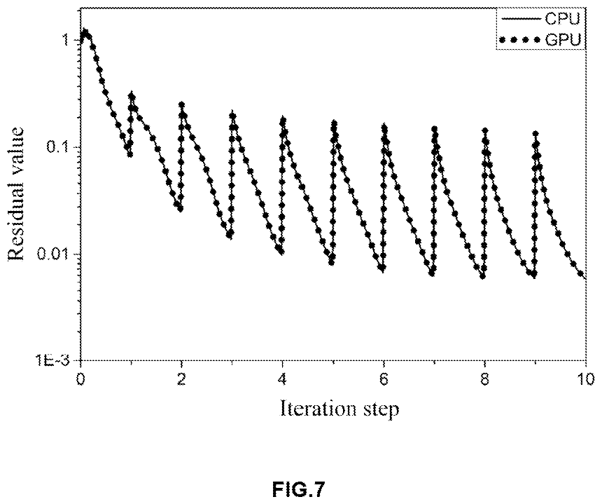

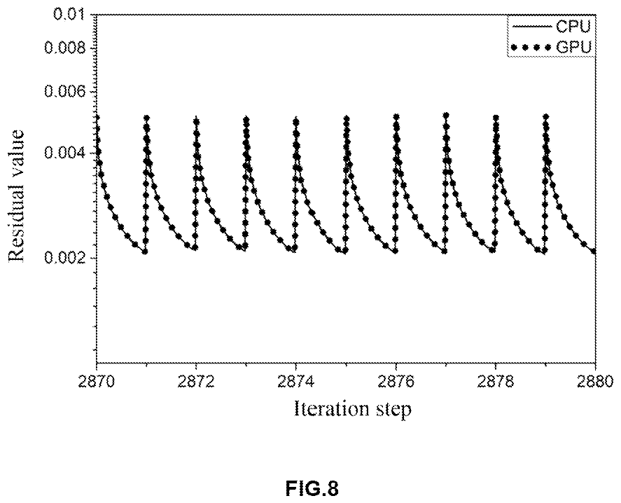

FIG. 6 shows cross-sectional aerodynamic data at 0.89 times the radius of the rotor blade of a Caradonna-Tung helicopter, which is computed by using the present disclosure. It can be seen that it is in good agreement with a test result. In this simulation case, there are 1497 thousand cell meshes, and a total of 2880 simulation times are computed. The number of iteration steps of each simulation time is 720. As shown in FIG. 7 and FIG. 8, the present disclosure compares residual value data only computed by using an Intel E5 2630 v2 CPU and accelerated computed by using an AMD RX 580 GPU, which is completely consistent with each other. This verifies validity of the method in the present disclosure and correctness of corresponding programming. It takes 55.66 hours to perform computing only by using the CPU, and it takes 10.96 hours to perform computing by using the GPU for accelerating. In this case, an acceleration effect of 5.1 times is implemented.

A batch processing policy is used in the present disclosure, so that functions that cannot be parallel are parallelized as much as possible to improve computational efficiency. In addition, because a corresponding cache required for data synchronization is reduced, GRAM occupation can be reduced, and memory access bandwidth can be reduced. The present disclosure computes the following two cases with unstructured meshes in an i-6800K CPU and an AMD R9 280X GPU.

Mesh 1: is a two-dimensional NACA0012 airfoil mesh with 26.4 thousand cells.

Mesh 2: is a three-dimensional 7A rotor blade mesh with 725.2 thousand cells.

Table 1 below shows an occupied GRAM and time-consuming when computing of 5000 and 100 iteration steps are respectively performed on the Mesh 1 and the Mesh 2. It can be learned that, through batch processing, GRAM occupation is reduced by 17.8% and 14.8%, and computing velocities are increased by 23% and 50%.

TABLE 1
Effect of face batch processing

| | Mesh 1 (5000 iteration steps) | | Mesh 2 (100 iteration steps) | |
|---|---|---|---|---|
| | GRAM | Time consumed | GRAM | Time consumed |
| | occupation | by computing | occupation | by computing |
| Conventional GPU | 10679.4 KB | 15.400 s | 329.89 MB | 7.609 s |
| computing mode | | | | |
| Batch processing manner in | 8779.1 KB | 12.488 s | 281.14 MB | 5.065 s |
| the present disclosure | | | | |

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Specific examples are used herein for illustration of principles and implementations of the present disclosure. The descriptions of the above embodiments are merely used for assisting in understanding the method of the present disclosure and its core ideas. In addition, those of ordinary skill in the art can make various modifications in terms of specific implementations and the scope of application in accordance with the ideas of the present disclosure. In conclusion, the content of the description shall not be construed as limitations to the present disclosure.

1. A graphics processing unit (GPU)-based numerical simulation system for a helicopter flow field (FF), comprising a central processing unit (CPU) and a GPU, wherein the CPU is connected to the GPU;
the CPU further comprises:
an initialization module, configured to initialize a moving overset grid according to a preset configuration file and mesh files of a to-be-simulated helicopter, wherein the moving overset grid comprises multiple mesh blocks;
a face batch determining module, connected to the GPU, and configured to determine face batch information according to the mesh blocks in the moving overset grid, and send the face batch information to the GPU, wherein the face batch information comprises multiple batches and a set of faces and cells corresponding to each batch;
an interpolation module, configured to determine an overset interpolation relationship between the mesh blocks and an interpolation mapping index according to mesh files of the to-be-simulated helicopter at a current simulation moment; and
an FF determining module, separately connected to the interpolation module and the GPU, and configured to perform FF information exchanging between the mesh blocks according to the overset interpolation relationship, the interpolation mapping index, and FF information of the mesh blocks, to obtain to-be-simulated helicopter FF information, wherein the FF information comprises density, velocity, and pressure; and
the GPU is separately connected to the face batch determining module and the FF determining module, and the GPU is configured to compute the FF information of the mesh blocks in the moving overset grid according to the face batch information by using a computational fluid dynamics (CFD) method, and send the FF information to the CPU.

2. The GPU-based numerical simulation system for a helicopter FF according to claim 1, wherein the GPU is further configured to convert the FF information of the mesh blocks into an array of structure (AoS) form, and send the FF information to the FF determining module.

3. The GPU-based numerical simulation system for a helicopter FF according to claim 1, wherein each of the mesh blocks comprises multiple faces and multiple cells; and the face batch determining module comprises:
an initialization submodule, configured to initialize, for any batch, a selected face set in the batch to empty;
a marking submodule, configured to: mark any face whose batch is undetermined in the mesh blocks as a selected face set in the batch, mark left and right cells of the face as occupied bodies, and mark another face of the occupied bodies as a collision face;
a traversal submodule, separately connected to the marking submodule and the initialization submodule, and configured to: sequentially traverse remaining faces whose batches are undetermined and that are adjacent to the selected face set; and if left and right cells of one of the faces are not occupied, mark the one face as a selected face set in the batch, and mark the corresponding left and right cells as occupied bodies; and
a batch determining submodule, separately connected to the traversal submodule and the GPU, and configured to obtain the face batch information after batches of all the faces in the mesh blocks are determined.

4. The GPU-based numerical simulation system for a helicopter FF according to claim 1, wherein the GPU comprises:
flux values determining module, connected to the face batch determining module, and configured to compute, for any batch, flux values of each face in parallel in the batch according to a preset boundary condition by using the CFD method;
an updating module, connected to the flux values determining module, and configured to update the flux values to left and right cells of the face; and
a mesh block FF determining module, separately connected to the updating module and the FF determining module, and configured to determine the FF information of the mesh blocks according to the flux values of the cells.

5. A GPU-based numerical simulation method for a helicopter FF, applied to the GPU-based numerical simulation system for a helicopter FF according to claim 1, and comprising:
initializing a moving overset grid according to a preset configuration file and mesh files of a to-be-simulated helicopter by using a CPU, wherein the moving overset grid comprises multiple mesh blocks;
determining face batch information according to the mesh blocks in the moving overset grid by using the CPU, wherein the face batch information comprises multiple batches and a set of faces and cells corresponding to each batch;
computing FF information of the mesh blocks in the moving overset grid according to the face batch information by using a GPU and a CFD method, wherein the FF information comprises density, velocity, and pressure; and
determining an overset interpolation relationship between the mesh blocks and an interpolation mapping index according to mesh files of the to-be-simulated helicopter at a current simulation moment by using the CPU, and performing FF information exchanging between the mesh blocks according to the overset interpolation relationship, the interpolation mapping index, and the FF information of the mesh blocks, to obtain to-be-simulated helicopter FF information.

6. The GPU-based numerical simulation method for a helicopter FF according to claim 5, further comprising:
converting the FF information of the mesh blocks into an AoS form by using the GPU.

7. The GPU-based numerical simulation method for a helicopter FF according to claim 5, wherein each of the mesh blocks comprises multiple faces and multiple cells; and the determining face batch information according to the mesh blocks in the moving overset grid by using the CPU specifically comprises:
initializing, for any batch, a selected face set in the batch to empty;
marking any face whose batch is undetermined in the mesh blocks as a selected face set in the batch, marking left and right cells of the face as occupied bodies, and marking another face of the occupied bodies as a collision face;
sequentially traversing remaining faces whose batches are undetermined and that are adjacent to the selected face set; if the left and right cells of one of the faces are not occupied, marking the one face as a selected face set in the batch, and marking the corresponding left and right cells as occupied bodies; and determining a next batch after traversing is completed; and
obtaining the face batch information after batches of all the faces in the mesh blocks are determined.

8. The GPU-based numerical simulation method for a helicopter FF according to claim 5, wherein the computing FF information of the mesh blocks in the moving overset grid according to the face batch information by using a GPU and a CFD method specifically comprises:
computing, for any batch, flux values of each face in parallel in the batch according to a preset boundary condition by using the CFD method;
updating the flux values to the left and right cells of the face; and
determining the FF information of the mesh blocks according to the flux values of the cells.

9. A GPU-based numerical simulation method for a helicopter FF, applied to the GPU-based numerical simulation system for a helicopter FF according to claim 2, and comprising:
initializing a moving overset grid according to a preset configuration file and mesh files of a to-be-simulated helicopter by using a CPU, wherein the moving overset grid comprises multiple mesh blocks;
determining face batch information according to the mesh blocks in the moving overset grid by using the CPU, wherein the face batch information comprises multiple batches and a set of faces and cells corresponding to each batch;
computing FF information of the mesh blocks in the moving overset grid according to the face batch information by using a GPU and a CFD method, wherein the FF information comprises density, velocity, and pressure; and
determining an overset interpolation relationship between the mesh blocks and an interpolation mapping index according to mesh files of the to-be-simulated helicopter at a current simulation moment by using the CPU, and performing FF information exchanging between the mesh blocks according to the overset interpolation relationship, the interpolation mapping index, and the FF information of the mesh blocks, to obtain to-be-simulated helicopter FF information.

10. A GPU-based numerical simulation method for a helicopter FF, applied to the GPU-based numerical simulation system for a helicopter FF according to claim 3, and comprising:
initializing a moving overset grid according to a preset configuration file and mesh files of a to-be-simulated helicopter by using a CPU, wherein the moving overset grid comprises multiple mesh blocks;
determining face batch information according to the mesh blocks in the moving overset grid by using the CPU, wherein the face batch information comprises multiple batches and a set of faces and cells corresponding to each batch;
computing FF information of the mesh blocks in the moving overset grid according to the face batch information by using a GPU and a CFD method, wherein the FF information comprises density, velocity, and pressure; and
determining an overset interpolation relationship between the mesh blocks and an interpolation mapping index according to mesh files of the to-be-simulated helicopter at a current simulation moment by using the CPU, and performing FF information exchanging between the mesh blocks according to the overset interpolation relationship, the interpolation mapping index, and the FF information of the mesh blocks, to obtain to-be-simulated helicopter FF information.

11. A GPU-based numerical simulation method for a helicopter FF, applied to the GPU-based numerical simulation system for a helicopter FF according to claim 4, and comprising:
initializing a moving overset grid according to a preset configuration file and mesh files of a to-be-simulated helicopter by using a CPU, wherein the moving overset grid comprises multiple mesh blocks;
determining face batch information according to the mesh blocks in the moving overset grid by using the CPU, wherein the face batch information comprises multiple batches and a set of faces and cells corresponding to each batch;
computing FF information of the mesh blocks in the moving overset grid according to the face batch information by using a GPU and a CFD method, wherein the FF information comprises density, velocity, and pressure; and
determining an overset interpolation relationship between the mesh blocks and an interpolation mapping index according to mesh files of the to-be-simulated helicopter at a current simulation moment by using the CPU, and performing FF information exchanging between the mesh blocks according to the overset interpolation relationship, the interpolation mapping index, and the FF information of the mesh blocks, to obtain to-be-simulated helicopter FF information.

12. The GPU-based numerical simulation method for a helicopter FF according to claim 9, further comprising:
converting the FF information of the mesh blocks into an AoS form by using the GPU.

13. The GPU-based numerical simulation method for a helicopter FF according to claim 10, further comprising:
converting the FF information of the mesh blocks into an AoS form by using the GPU.

14. The GPU-based numerical simulation method for a helicopter FF according to claim 11, further comprising:
converting the FF information of the mesh blocks into an AoS form by using the GPU.

15. The GPU-based numerical simulation method for a helicopter FF according to claim 9, wherein each of the mesh blocks comprises multiple faces and multiple cells; and the determining face batch information according to the mesh blocks in the moving overset grid by using the CPU specifically comprises:
initializing, for any batch, a selected face set in the batch to empty;
marking any face whose batch is undetermined in the mesh blocks as a selected face set in the batch, marking left and right cells of the face as occupied bodies, and marking another face of the occupied bodies as a collision face;
sequentially traversing remaining faces whose batches are undetermined and that are adjacent to the selected face set; if the left and right cells of one of the faces are not occupied, marking the one face as a selected face set in the batch, and marking the corresponding left and right cells as occupied bodies; and determining a next batch after traversing is completed; and
obtaining the face batch information after batches of all the faces in the mesh blocks are determined.

16. The GPU-based numerical simulation method for a helicopter FF according to claim 10, wherein each of the mesh blocks comprises multiple faces and multiple cells; and the determining face batch information according to the mesh blocks in the moving overset grid by using the CPU specifically comprises:
initializing, for any batch, a selected face set in the batch to empty;
marking any face whose batch is undetermined in the mesh blocks as a selected face set in the batch, marking left and right cells of the face as occupied bodies, and marking another face of the occupied bodies as a collision face;
sequentially traversing remaining faces whose batches are undetermined and that are adjacent to the selected face set; if the left and right cells of one of the faces are not occupied, marking the one face as a selected face set in the batch, and marking the corresponding left and right cells as occupied bodies; and determining a next batch after traversing is completed; and
obtaining the face batch information after batches of all the faces in the mesh blocks are determined.

17. The GPU-based numerical simulation method for a helicopter FF according to claim 11, wherein each of the mesh blocks comprises multiple faces and multiple cells; and the determining face batch information according to the mesh blocks in the moving overset grid by using the CPU specifically comprises:
initializing, for any batch, a selected face set in the batch to empty;
marking any face whose batch is undetermined in the mesh blocks as a selected face set in the batch, marking left and right cells of the face as occupied bodies, and marking another face of the occupied bodies as a collision face;
sequentially traversing remaining faces whose batches are undetermined and that are adjacent to the selected face set; if the left and right cells of one of the faces are not occupied, marking the one face as a selected face set in the batch, and marking the corresponding left and right cells as occupied bodies; and determining a next batch after traversing is completed; and
obtaining the face batch information after batches of all the faces in the mesh blocks are determined.

18. The GPU-based numerical simulation method for a helicopter FF according to claim 9, wherein the computing FF information of the mesh blocks in the moving overset grid according to the face batch information by using a GPU and a CFD method specifically comprises:
computing, for any batch, flux values of each face in parallel in the batch according to a preset boundary condition by using the CFD method;
updating the flux values to the left and right cells of the face; and
determining the FF information of the mesh blocks according to the flux values of the cells.

19. The GPU-based numerical simulation method for a helicopter FF according to claim 10, wherein the computing FF information of the mesh blocks in the moving overset grid according to the face batch information by using a GPU and a CFD method specifically comprises:
computing, for any batch, flux values of each face in parallel in the batch according to a preset boundary condition by using the CFD method;
updating the flux values to the left and right cells of the face; and
determining the FF information of the mesh blocks according to the flux values of the cells.

20. The GPU-based numerical simulation method for a helicopter FF according to claim 11, wherein the computing FF information of the mesh blocks in the moving overset grid according to the face batch information by using a GPU and a CFD method specifically comprises:
computing, for any batch, flux values of each face in parallel in the batch according to a preset boundary condition by using the CFD method;
updating the flux values to the left and right cells of the face; and
determining the FF information of the mesh blocks according to the flux values of the cells.
